(19) United States
(12) Patent Application Publication
(10) Pub. No.: US 2007/0045897 A1
(43) Pub. Date: Mar. 1, 2007

(54) Plastic tray for manufacturing a simulated stone product

(76) Inventors: Cliff Alexander, Napa, CA (US); Robert Ugianskis, Fairfield, CA (US); Donn R. Vermilion, Newark, OH (US)

Correspondence Address: OWENS CORNING, 2790 COLUMBUS ROAD, GRANVILLE, OH, 43023, US

(21) Appl. No.: 11/209,565

(22) Filed: Aug. 23, 2005

(51) Int. Cl. B29C 33/40

(52) U.S. Cl. 264/225; 249/127

(57) ABSTRACT

A mold for manufacturing a simulated stone product includes a flexible layer having a mold cavity in the shape of the simulated stone product. The flexible layer includes a first surface in which the mold cavity is formed and a second surface opposite the first surface. The mold also includes a structural foam that conforms to the shape of the second surface of the flexible layer and provides support to the second surface. The mold further includes a plastic tray holding the structural foam and the flexible layer. Also described are a plastic tray for constructing a mold to manufacture a simulated stone product, and a method of manufacturing a simulated stone product.

### BACKGROUND OF THE INVENTION

The invention relates in general to apparatuses and methods for producing cast articles, and in particular to a plastic tray for constructing a mold to manufacture a simulated stone product, and to a method of manufacturing a simulated stone product using the tray.

Simulated stone products include simulated stone veneers and simulated stone architectural trim products. Simulated stone veneers are used as a lightweight veneer facing on masonry, metal framed, or wood framed construction for architectural aesthetics. The products can be used for exterior applications such as building walls or interior applications such as fireplaces. Simulated stone architectural trim products include capstones, hearthstones, keystones, trimstones and the like. The simulated stone products are usually lower in cost than the natural stones that they replace. CULTURED STONE® products are simulated stone products manufactured by Cultured Stone Corporation, a division of Owens Corning, Napa, Calif. The Cultured Stone product line includes hundreds of precast stone veneers and architectural trim products that replicate an extensive variety of textures, sizes, shapes and colors of natural stone. The products are manufactured by casting them in molds taken from natural stones. The molds include a latex layer having a mold cavity, a structural foam that supports the bottom of the latex layer, and a tray that holds the foam and the latex layer. The current trays include a metal frame and a plywood bottom.

Several patents or published applications disclose polymer molds used to manufacture stone or cement articles. For example, U.S. Patent Application Publication No. 2004/0070106 discloses a method and apparatus for molding articles such as stone panels. The molds are preferably formed from flexible polymer materials. Each of U.S. Pat. Nos. 3,995,086 and 4,036,839 discloses a shaped cement article cast in a polymer mold.

### SUMMARY OF THE INVENTION

The invention relates to a mold for manufacturing a simulated stone product. The mold includes a flexible layer having a mold cavity in the shape of the simulated stone product. The flexible layer includes a first surface in which the mold cavity is formed and a second surface opposite the first surface. The mold also includes a structural foam that conforms to the shape of the second surface of the flexible layer and provides support to the second surface. The mold further includes a plastic tray holding the structural foam and the flexible layer.

Another embodiment of the invention relates to a plastic tray for constructing a mold to manufacture a simulated stone product. The plastic tray is structured to hold a flexible layer having a mold cavity in the shape of the simulated stone product. The flexible layer includes a first surface in which the mold cavity is formed and a second surface opposite the first surface. The tray is also structured to hold a structural foam that conforms to the shape of the second surface of the flexible layer and provides support to the second surface. The tray includes at least one opening for introducing the structural foam between the tray and the flexible layer. The tray also includes at least one stiffening structure that increases rigidity of the tray.

Another embodiment of the invention relates to a method of manufacturing a simulated stone product. A flexible layer is applied over a master mold that includes a natural stone protruding from a base, so that the flexible layer conforms to the shape of the protruding natural stone to form a mold cavity in a first surface of the flexible layer. The flexible layer also includes a second surface opposite the first surface. A plastic tray is positioned over the master mold to enclose the flexible layer. A structural foam is introduced between the plastic tray and the flexible layer, so that the foam conforms to the shape of the second surface of the flexible layer and provides support to the second surface. The plastic tray, the structural foam and the flexible layer are removed from the master mold. A production mold is formed by positioning the plastic tray, the structural foam and the flexible layer so that the plastic tray holds the structural foam and the flexible layer, and the structural foam provides support to the second surface of the flexible layer. A castable material is introduced into the mold cavity in the first surface of the flexible layer. The castable material is allowed to harden to form the simulated stone product. The simulated stone product is then removed from the mold cavity.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view showing apparatuses for manufacturing simulated stone veneers in the form of flat pieces. In particular, the figure shows a master mold, a flexible layer coated on top of the master mold and following its contours, a plastic tray according to the invention ready to be positioned over the master mold, and a rigid fixture ready to be positioned over the plastic tray.

FIG. 2 is a partial sectional view of the apparatuses of FIG. 1 after the plastic tray has been positioned over the master mold and the flexible layer, and the rigid fixture has been positioned over the plastic tray.

FIG. 3 is a view like in FIG. 2 after a structural foam has been injected between the flexible layer and the plastic tray.

FIG. 4 is a view of the apparatuses after the rigid fixture has been removed, after inversion of the plastic tray holding the structural foam and the flexible layer, and after a castable material has been introduced into the mold cavities formed in the flexible layer.

FIG. 5 is a view of the apparatuses after the castable material has hardened to form the simulated stone veneers in the form of flat pieces, and after air has been injected between the flexible layer and the structural foam to inflate and separate the center of the flexible layer from the structural foam, in order to separate the simulated stone veneers from the flexible layer.

FIGS. 6-9 show the same manufacturing method as in FIGS. 2-5, except that the apparatuses are designed for manufacturing simulated stone veneers in the form of corner pieces instead of flat pieces. In particular, FIG. 6 is a partial sectional view of the apparatuses after the plastic tray has been positioned over the master mold and the flexible layer, and the rigid fixture has been positioned over the plastic tray.

FIG. 7 is a view like in FIG. 6 after a structural foam has been injected between the flexible layer and the plastic tray.

FIG. 8 is a view of the apparatuses after the rigid fixture has been removed, after inversion of the plastic tray holding the structural foam and the flexible layer, and after a castable material has been introduced into the mold cavity formed in the flexible layer.

FIG. 9 is a view of the apparatuses after the castable-material has hardened to form the simulated stone veneer in the form of a corner piece, and after air has been injected between the flexible layer and the structural foam to inflate and separate the center of the flexible layer from the structural foam, in order to separate the simulated stone veneer from the flexible layer.

FIG. 10 is a perspective view of the plastic tray according to the invention shown in FIG. 1.

FIG. 11 is a plan view of the plastic tray of FIG. 10.

FIG. 12 is a side elevational view of the plastic tray of FIG. 10.

FIG. 13 is a partial sectional view taken along line 13-13 of FIG. 11.

FIG. 14 is a perspective view of another embodiment of a plastic tray according to the invention.

### DETAILED DESCRIPTION OF THE PREFERRED EMBODIMENTS

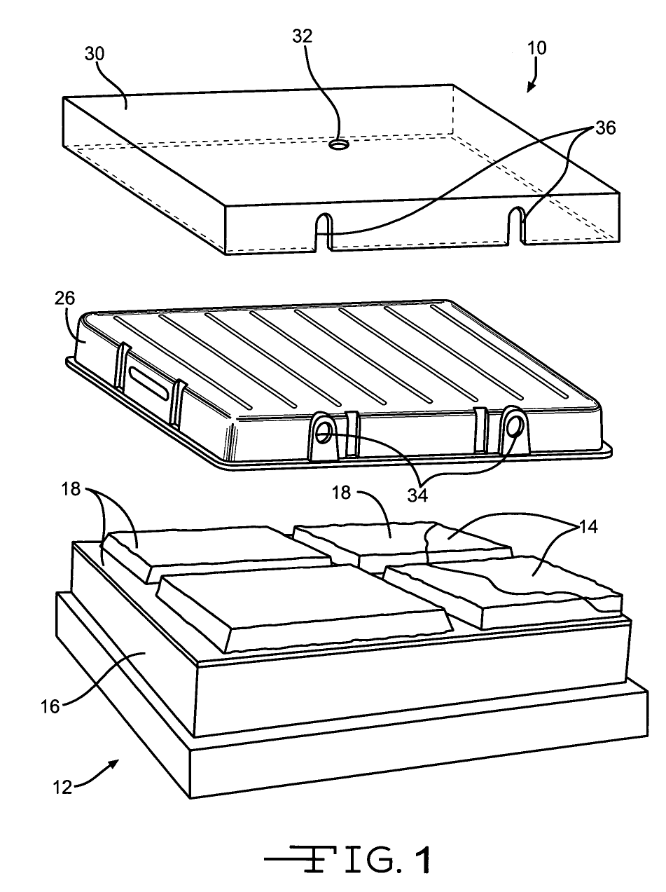

Referring to the drawings, FIG. 1 shows apparatuses 10 used in a method of manufacturing simulated stone veneers in the form of flat pieces according to the invention. Although the method is illustrated in relation to simulated stone veneers, the method can also be used to manufacture simulated stone architectural trim products. The apparatuses include a master mold 12. The master mold 12 is produced by setting natural stones 14 in the top of a base 16 so that the stones protrude from the base. This can be accomplished in any suitable manner. Generally, the master mold is made by pouring a curable urethane or similar curable material around the natural stones 14 in the base 16, and allowing the urethane to cure to set the stones in the base.

For the sake of simplification, in the illustrated method the natural stones 14 are flat pieces that are large and generally square-shaped. However, any desired type of natural stones can be simulated by the method. For example, the CULTURED STONE® products include the following. Cultured Stone® Textures: Blended Textures, Cobblefield®, Coral Stone, Country. Ledgestone, Dressed Fieldstone, Drystack Ledgestone, European Castle, Fieldstone, Limestone, Old Country Fieldstone, Pro-Fit Ledgestone®, River Rock, Southern Ledgestone, Split Face, Stream Stones and Weather Edge Ledgestone. Cultured Brick®: Used Brick. Architectural Trim: Capstones, Hearthstones, Keystones and Trim Stones, Quoins, Tuscan Lintels, Watertables and Sills. These products are illustrated on the web site www.culturedstone.com. The simulated stone products can be in the form of flat pieces, corner pieces, hearth pieces and architectural trim products.

The apparatuses 10 also include a flexible layer 18 covering the top of the master mold 12. The flexible layer 18 is applied such that it conforms to the shape of the natural stones 14 and the top of the base 16, closely following their contours. FIG. 1 is partially cut away to show the natural stones 14 under the flexible layer 18. The flexible layer 18 can be made from any suitable flexible material and applied by any suitable method. The flexible material is able to conform its shape around the natural stones and then to retain that shape during the remainder of the method. In one embodiment, the flexible layer is a curable rubber material such as latex or silicone rubber. The uncured rubber is applied to the top of master mold such that it closely follow its contours. For example, the uncured rubber can be applied by spraying and/or brushing it on top of the master mold until it forms a continuous layer. The uncured rubber is then allowed to cure until it hardens but retains it flexibility and its contoured shape. The flexible layer can have any suitable thickness; typically, it is a relatively thin layer having a thickness between about ⅛ inch and about ⅜ inches.

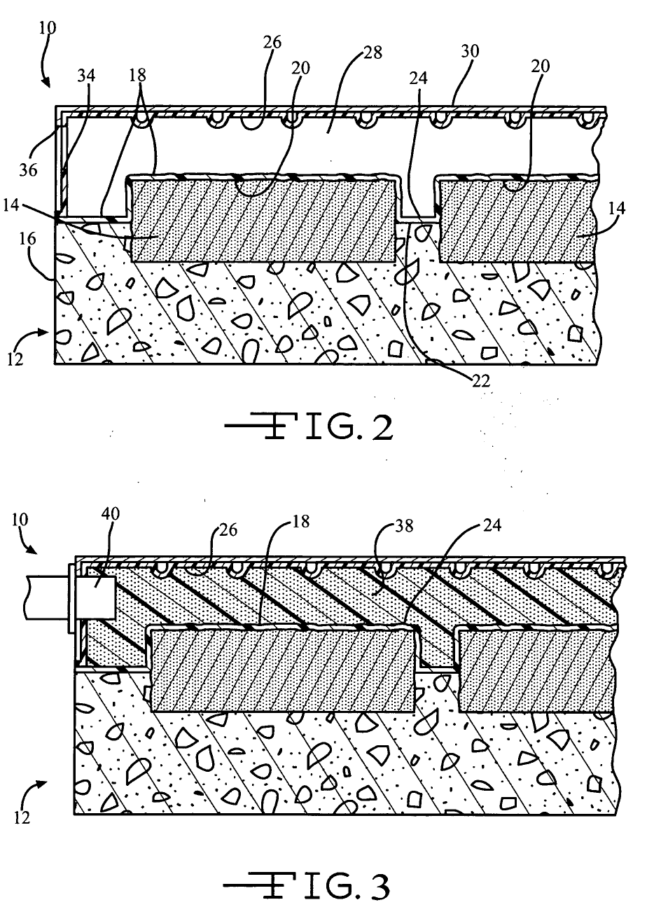

As best shown in FIG. 2, the master mold 12 includes the natural stones 14 set in the base 16 and protruding upward therefrom. The flexible layer 18 covers the top of the natural stones 14 and the base 16. The flexible layer 18 conforms to the shape of the protruding natural stones 14 to form mold cavities 20 in a first surface 22 of the flexible layer. The mold cavities 20 are in the shape of the protruding portions of the natural stones 14, and the mold cavities are also in the shape of the simulated stone veneers as described below. The flexible layer also includes a second surface 24 opposite the first surface 22.

Referring to FIGS. 1 and 2, the apparatuses 10 also include a plastic tray 26 according to the invention. The plastic tray 26 is structured to be positioned over the master mold 12 to enclose the flexible layer 18. FIG. 1 shows the plastic tray 26 ready to be positioned over the master mold 12, while FIG. 2 shows the plastic tray 26 having been lowered into position over the master mold 12 to enclose the flexible layer 18. The edges of the plastic tray sit flat on the flexible layer on the top surface of the base around the natural stones. As shown in FIG. 2, a space 28 remains between the plastic tray 26 and the flexible layer 18. The plastic tray 26 is described in more detail below.

As shown in FIGS. 1 and 2, the apparatuses 10 may also include a rigid fixture 30. The rigid fixture 30 is structured to be positioned over the plastic tray 26 after the plastic tray has been positioned over the master mold 12. The rigid fixture 30 is positioned adjacent to the plastic tray 26 such that it supports the tray during the injection of structural foam between the plastic tray and the flexible layer, as described below. The rigid fixture 30 can be made from any suitable material, for example a metal such as steel. During the foam injection process, the rigid fixture holds the plastic tray against the top of the flexible layer and the master mold to prevent it from separating when subjected to the pressure of the injected foam. The rigid fixture can be held in place on top of the master mold by any suitable means. In the illustrated embodiment, the rigid fixture 30 has an optional hole 32 to allow attachment of chains (not shown) that hold the fixture to the master mold.

The plastic tray 26 includes at least one opening for introducing the structural foam between the tray and the flexible layer 18. In the illustrated embodiment, the plastic tray 26 includes two such openings 34. The rigid fixture 30 is structured to provide access to the openings 34 from the exterior of the fixture. In the embodiment shown, the rigid fixture 30 includes two slots 36 that overlap the openings 34 and are sized to provide access to the openings.

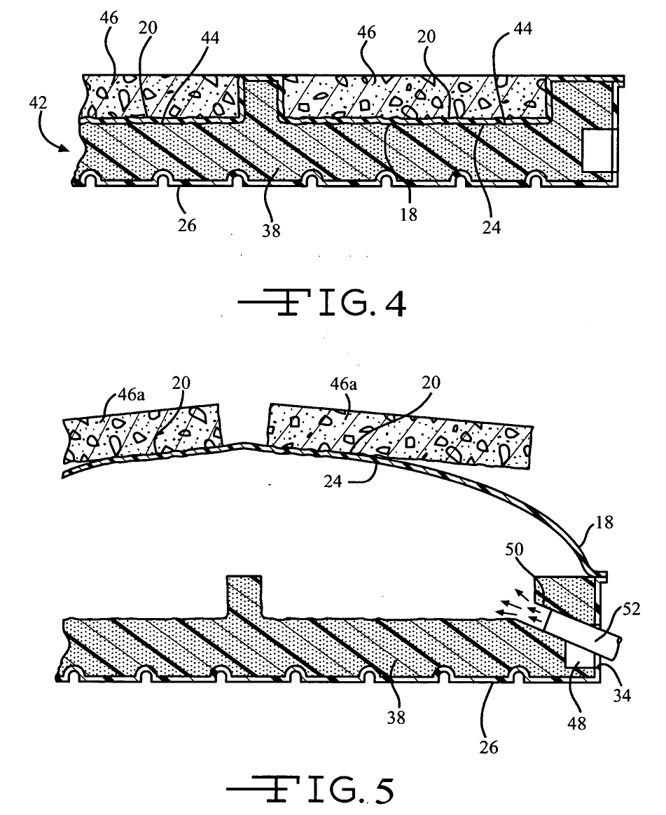

As shown in FIGS. 2 and 3, a structural foam 38 is introduced into the space 28 between the plastic tray 26 and the flexible layer 18. The structural foam 38 conforms to the shape of the second surface 24 of the flexible layer 18. In the illustrated embodiment, the structural foam 38 fills the space 28 between the plastic tray 26 and the flexible layer 18. The structural foam 38, when hardened, provides support to the second surface 24 of the flexible layer 18 during the remaining steps of the manufacturing method as described below. Typically, before introducing the structural foam 38, a release agent is applied to the second surface 24 of the flexible layer 18 to prevent the foam from adhering to it before the foam hardens. The structural foam 38 can be introduced by any suitable means. In the illustrated embodiment, the structural foam 38 is introduced by inserting a foam injection nozzle 40 through a slot 36 in the rigid fixture 30 and a corresponding opening 34 in the plastic tray 26, and injecting a curable structural foam 38 into the space 28. A second foam injection nozzle (not shown) can be used to inject structural foam through the second opening 34 in the plastic tray 26, or the first foam injection nozzle 40 can be switched to the second opening after injecting through the first opening.

The cured structural foam 38 is a rigid, load supporting foam capable of adding structural strength. Any suitable type of structural foam can be used in the manufacturing method. Some examples include polyurethane, polystyrene and polyphenylene oxide; many other types of structural foams are well known.

After the structural foam 38 has cured, the rigid fixture 30 is removed from over the plastic tray 26. Then the plastic tray 26 and the structural foam 38 are removed from the master mold 12. The flexible layer 18 is also removed from the master mold 12. The flexible layer 18 may be removed along with the plastic tray 26 and the structural foam 38, or it may be removed separately. For example, the flexible layer 18 may tend to adhere to the master mold 12, so that it is removed separately by peeling it off the master mold after the plastic tray and the structural foam have been removed. The flexible layer retains its shape after removal from the master mold; in particular, the shapes of the mold cavities 20 are retained in the flexible layer.

As shown in FIG. 4, the next step of the manufacturing method is to form a production mold 42 by positioning the plastic tray 26, the structural foam 38 and the flexible layer 18 so that the plastic tray 26 holds the structural foam 38 and the flexible layer 18, and the structural foam 38 provides support to the second surface 24 of the flexible layer 18. In the illustrated embodiment, this is done by inverting the plastic tray 26 and the structural foam 38 and setting them on a suitable surface (not shown), such as a conveyor belt in a manufacturing plant. If the flexible layer 18 has been removed separately from the master mold 12, the flexible layer 18 is inverted and placed onto the structural foam 38 such that the mold cavities 20 are positioned in the corresponding recesses 44 in the structural foam 38.

After the production mold 42 has been set in position, a castable material 46 is introduced into the mold cavities 20 formed in the flexible layer 18. The castable material 46 can be introduced by any suitable means, such as by pouring it into the mold cavities 20. The production mold 42 may be vibrated after introducing the castable material into the mold cavity to insure that the castable material flows into all the contours of the mold cavity. Also, the upper surface of the castable material in the mold cavity may be raked to level the surface and to provide a textured surface to assist in bonding the finished product to mortar during installation of the product.

After hardening, the castable material 46 in each of the mold cavities 20 becomes a simulated stone veneer 46a, as shown in FIG. 5. In the illustrated embodiment, the simulated stone veneers 46a are in the form of flat pieces. Any suitable castable material 46 can be used for producing the simulated stone veneers. In one embodiment, the castable material is a lightweight concrete material comprising Portland cement and lightweight aggregates. However, other castable materials could be used, such as plaster of Paris or a ceramic material. One or more coloring materials can be used in the castable material so that the simulated stone veneers replicate the colors of the desired natural stones. Any suitable coloring materials can be used, such as different colored iron oxide pigments.

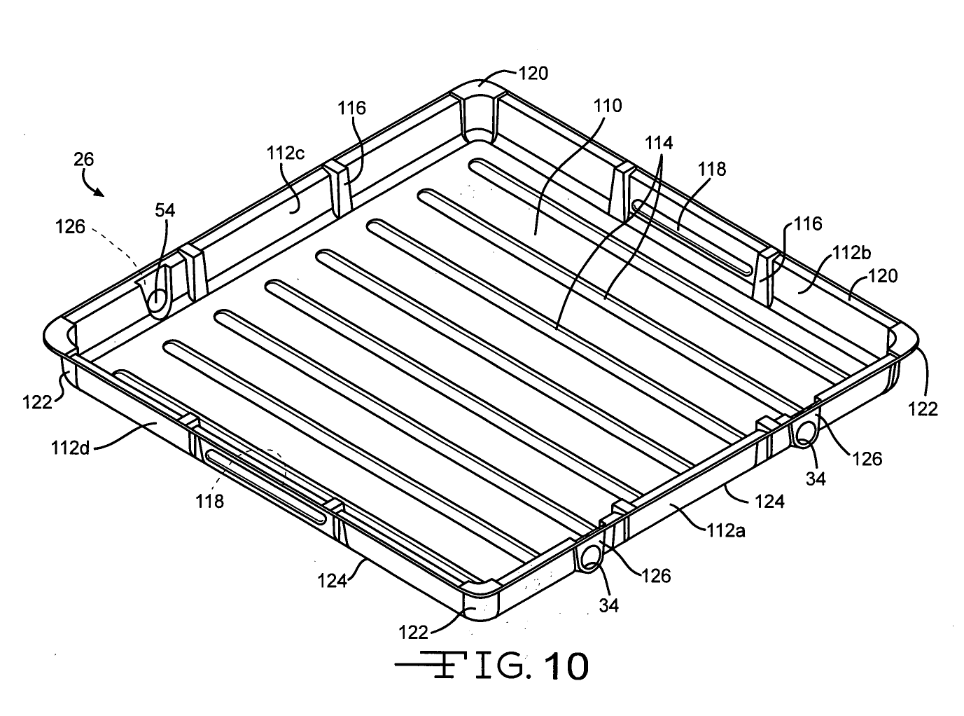

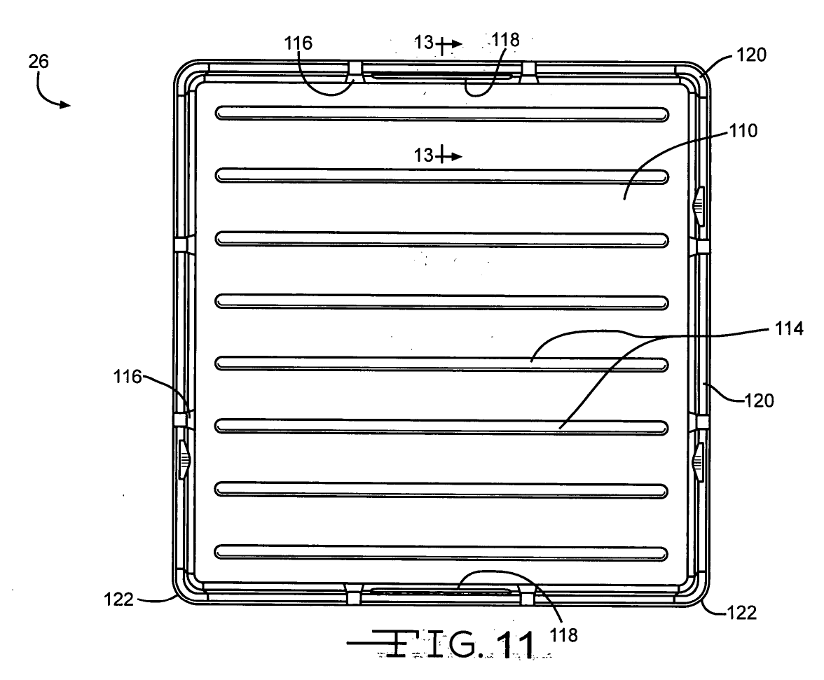

The simulated stone veneers 46a are then removed from the mold cavities 20. Any suitable means can be used for removing the simulated stone veneers 46a. One embodiment of a means for removing the simulated stone veneers 46a is partially illustrated in FIG. 5. Adjacent to the opening 34 in the plastic tray 26, a void 48; remains in the structural foam 38 at the location where the foam injection nozzle 40 (FIG. 3) was inserted. A bore 50 is formed through the structural foam 38, extending between the void 48 and the second surface 24 of the flexible layer 18. Any suitable method can be used to form the bore 50, such as by drilling or cutting through the structural foam 38. Then an air injection nozzle 52 is inserted through the void 48 and into the bore 50. The air injection nozzle 52 blows pressurized air against the second surface 24 of the flexible layer 18. The edges of the flexible layer 18 are clamped on the plastic tray 26. As shown in FIG. 5, the injection of the air causes the center of the flexible layer 18 to inflate and separate from the structural foam 38, in order to separate the simulated stone veneers 46a from the mold cavities 20 in the flexible layer. As shown in FIG. 10, the plastic tray 26 may also have another opening 54 on the opposite side of the tray for the injection of air. A bore (not shown) may be formed between the opening 54 and the second surface 24 of the flexible layer 18.

The simulated stone veneers 46a are usually relatively thin compared to the natural stones that they replace. For example, the simulated stone veneers may have a thickness of up to about 3 inches, and an average thickness of about 1¾ inches, compared to natural stones that have more depth.

The simulated stone products are usually installed by cementing them in place with mortar. For example, the simulated stone veneers are usually applied with mortar to any suitable wall surface, resulting in a permanent and strong attachment of the veneer to the wall surface. Optionally, one or more layers of different material (e.g., insulation, sheathing and/or weather-resistant material) may be first applied to the wall surface, before applying the simulated stone veneers with mortar to the outermost of those layers.

FIGS. 6-9 show the same manufacturing method as in FIGS. 2-5, except that the apparatuses 60 are designed for manufacturing simulated stone veneers 96a in the form of corner pieces instead of flat pieces. Referring to FIG. 6, the master mold 62 includes a natural stone 64 in the form of an L-shaped corner piece set in a base 66. Although it is not visible in FIG. 6, the master mold 62 generally extends in a direction away from the viewer, so that the master mold 62 includes a plurality of the natural stones 64 set side by side.

The apparatuses 60 also include a flexible layer 68 covering the top of the master mold 62. The flexible layer 68 conforms to the shape of the protruding natural stone 64 to form a mold cavity 70 in a first surface 72 of the flexible layer. The mold cavity 70 is in the shape of the protruding portion of the natural stone 64, and the mold cavity is also in the shape of the simulated stone veneer as described below.

The apparatuses 60 also include a plastic tray 76 according to the invention. The plastic tray 76 is structured to be positioned over the master mold 62 to enclose the flexible layer 68. Like the master mold 62, the plastic tray 76 extends in a direction away from the viewer, so that the plastic tray 76 has an elongated shape with an L-shaped cross section. A space 78 remains between the plastic tray 76 and the flexible layer 68.

The apparatuses 60 may also include a rigid fixture 80. The rigid fixture 80 is structured to be positioned over the plastic tray 76 after the plastic tray has been positioned over the master mold 62, and then held in place by chains or other means.

The plastic tray 76 includes at least one opening 84 for introducing a structural foam between the tray and the flexible layer 68. The rigid fixture 80 includes a slot 86 that overlaps the opening 84 and is sized to provide access to the opening.

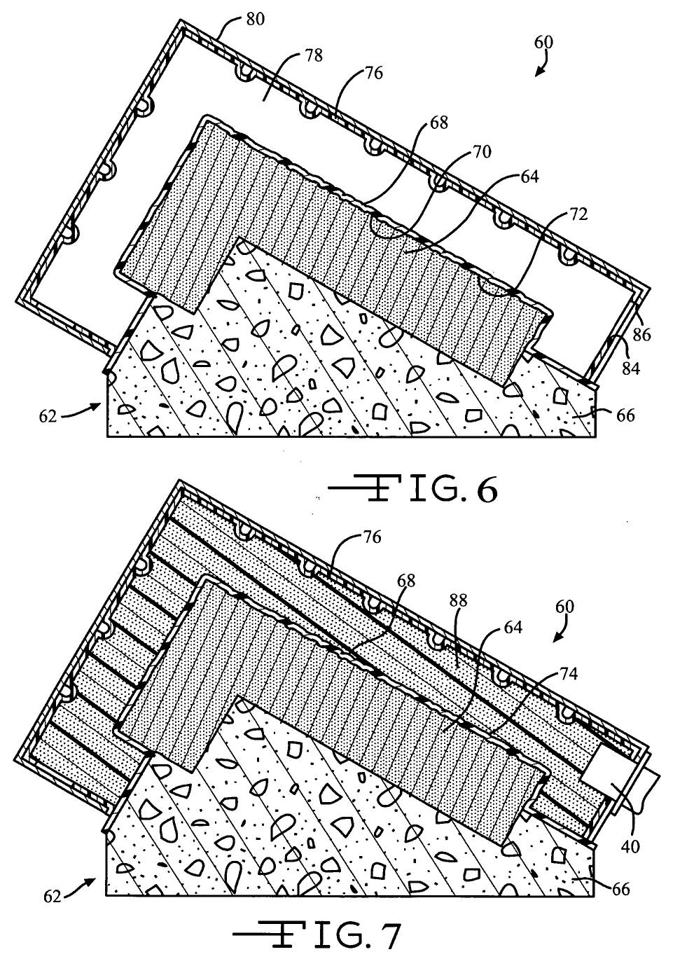

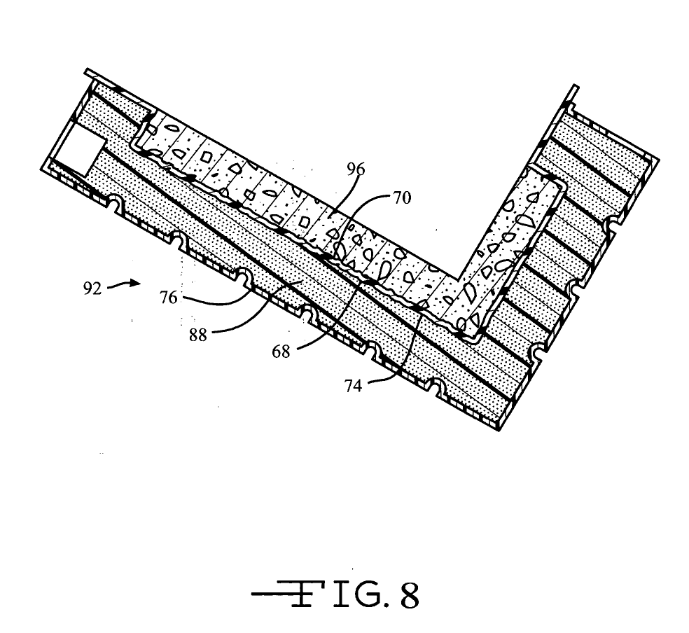

As shown in FIGS. 6 and 7, the structural foam 88 is introduced into the space 78 between the plastic tray 76 and the flexible layer 68. The structural foam 88 conforms to the shape of the second surface 74 of the flexible layer 68. The structural foam 88, when hardened, provides support to the second surface 74 of the flexible layer 68 during the remaining steps of the manufacturing method. In the illustrated embodiment, the structural foam 88 is introduced by inserting a foam injection nozzle 40 through the slot 86 in the rigid fixture 80 and the corresponding opening 84 in the plastic tray 76, and injecting a curable structural foam 88 into the space 78.

After the structural foam 88 has cured, the rigid fixture 80 is removed from over the plastic tray 76. Then the plastic tray 76 and the structural foam 88 are removed from the master mold 62. The flexible layer 68 is also removed from the master mold 62.

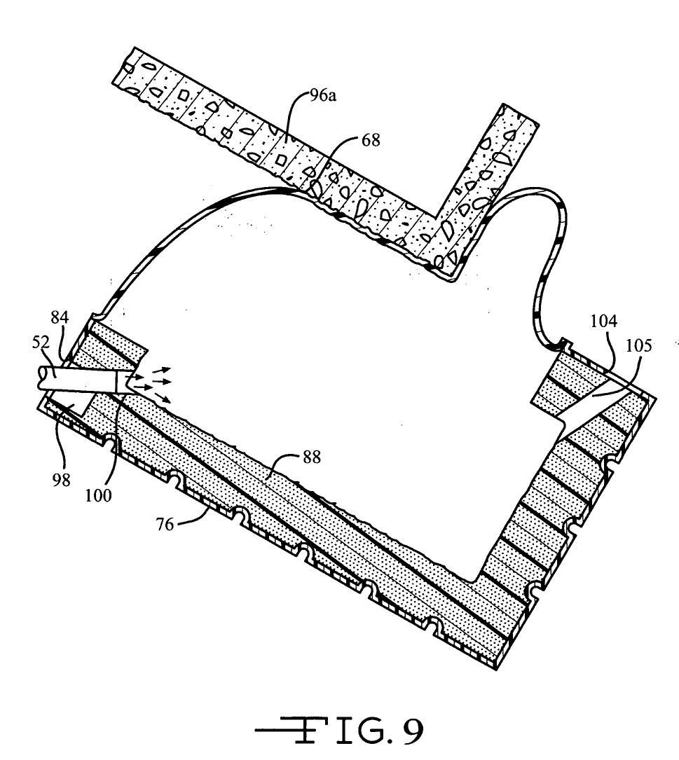

As shown in FIG. 8, a production mold 92 is formed by positioning the plastic tray 76, the structural foam 88 and the flexible layer 68 so that the plastic tray 76 holds the structural foam 88 and the flexible layer 68, and the structural foam 88 provides support to the second surface 74 of the flexible layer 68.

After the production mold 92 has been set in position, a castable material 96 is introduced into the mold cavity 70 formed in the flexible layer 68. After hardening, the castable material 96 in the mold cavity 70 becomes a simulated stone veneer 96a in the form of a corner piece, as shown in FIG. 9.

The simulated stone veneer 96a is then removed from the mold cavity 70. Adjacent to the opening 84 in the plastic tray 76, a void 98 remains in the structural foam 88 at the location where the foam injection nozzle 40 (FIG. 7) was inserted. A bore 100 is formed through the structural foam 88, extending between the void 98 and the second surface 74 of the flexible layer 68. Then an air injection nozzle 52 is inserted through the void 98 and into the bore 100. The air injection nozzle 52 blows pressurized air against the second surface 74 of the flexible layer 68. The edges of the flexible layer 68 are clamped on the plastic tray 74. As shown in FIG. 9, the injection of the air causes the center of the flexible layer 68 to inflate and separate from the structural foam 88, in order to separate the simulated stone veneer 96a from the mold cavity 70 in the flexible layer. The plastic tray 76 may also have another opening 104 opposite the opening 84 for air injection. A bore 105 may be formed between the opening 104 and the second surface 74 of the flexible layer 68.

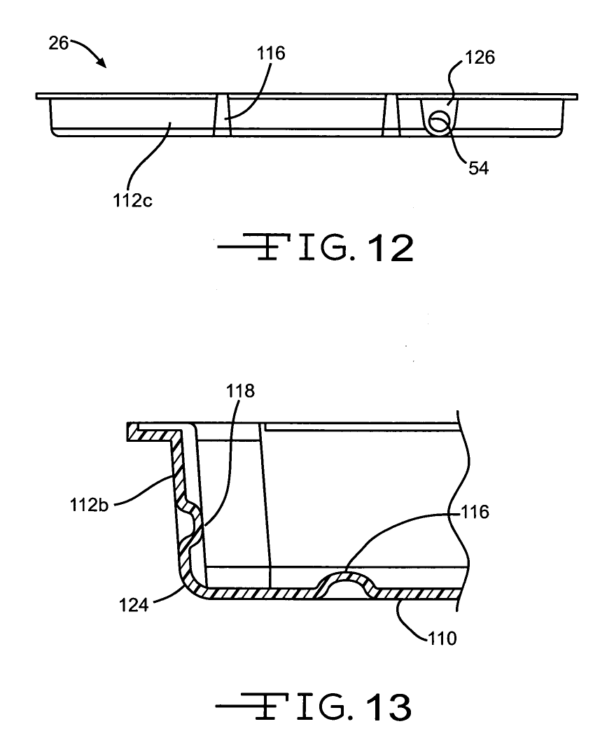

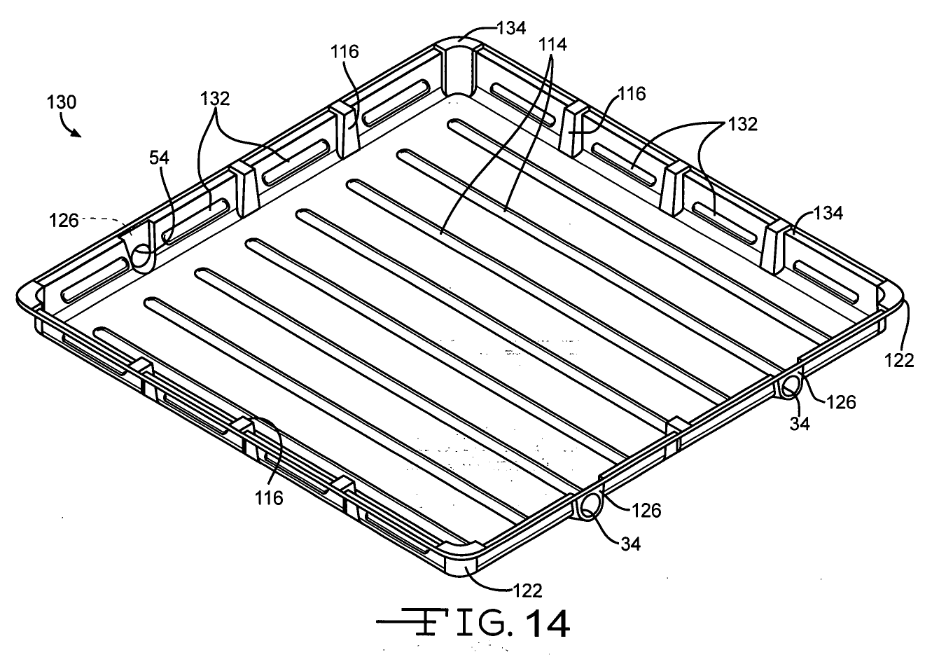

FIGS. 10-13 illustrate in more detail the plastic tray 26 which was shown in FIGS. 1-5. The illustrated plastic tray 26 is square-shaped with a flat bottom 110 and four sides 112a-d extending upward a short distance from the bottom. However, the plastic tray can have any suitable shape depending primarily on the shape of the master mold. For example, the plastic tray shown in FIG. 6 has an extended L-shape. The plastic tray 26 can also have any suitable dimensions. In one embodiment, the plastic tray 26 is 48 inches×48 inches at the inside bottom and 4 inches deep.

In contrast to the previously used trays including a metal frame and a plywood bottom, the plastic tray 26 according to the invention is made from plastic. Preferably, the tray is made from a flexible plastic material. A flexible plastic tray is generally more resistant to damage than the metal/plywood tray, so that it can be reused in the manufacturing operation for a longer period of time. The flexibility allows the plastic tray to bend on the production line. Also, it can regain its original shape after being deformed. The plastic tray is also lighter than the metal/plywood tray. Any suitable plastic/polymeric material can be used to make the plastic tray. In one embodiment, the plastic tray is made from a thermoformable plastic. Two specific examples of thermoformable plastics that may be suitable include polyethylene and acrylonitrile-butadiene-styrene copolymer (ABS). Other examples of thermoformable plastics include polypropylene, polybutene, poly(4-methyl-pentene), ethylene/propylene copolymers, ethylene/butene copolymers, propylene/butene copolymers, ethylene/vinyl alkanoate copolymers, ethylene/alkylacrylate copolymers, and ethylene/alkylmethacrylate copolymers. Many other types of thermoformable plastics are well known.

The plastic tray 26 can be made from plastic having any suitable thickness for providing the tray with its functional properties. In one embodiment, the thickness of the plastic used to make the plastic tray 26 is between about 0.15 inch and about 0.25 inch.

The plastic tray 26 includes at least one opening 34 for introducing the structural foam between the tray and the flexible layer, as described above. Any suitable number of openings can be used. In the illustrated embodiment, the plastic tray 26 includes two openings 34 through one side 112a of the tray, and a third opening 54 through an opposite side 112c of the tray. As described above, the two openings 34 can be used for injecting the structural foam, and subsequently one of the openings 34 can be used for injecting air to separate the flexible layer from the tray and the flexible foam. The third opening 54 allows the air to pass through the opposite side of the tray.

The plastic tray 26 also includes at least one stiffening structure that increases rigidity of the tray. Any suitable stiffening structure(s) can be used, such as ribs, offsets, webs, or other such structures. In the illustrated embodiment, the bottom 110 of the plastic tray 26 includes a plurality of stiffening ribs 114. The sides 112a-d of the plastic tray include a plurality of offsets 116 or ribs that increase the rigidity of the sides.

The plastic tray 26 may also include at least one locking structure that locks the structural foam inside the tray. This retains the structural foam inside the plastic tray when the tray is removed from the top of the master mold. Any suitable locking structure(s) can be included. In the illustrated embodiment, opposite sides 112b and 112d of the plastic tray 26 include extended protrusions 118 that protrude a short distance into the interior of the tray. The structural foam locks around these protrusions to mechanically hold the foam in place during the stone manufacturing operation. In another embodiment, the locking structure(s) can be cavities instead of protrusions.

The plastic tray 26 may further include at least one stacking structure that facilitates stacking the tray with a second tray. For example, during the manufacturing operation it may be desirable to stack a plurality of trays on top of each other while the castable material hardens. Any suitable stacking feature(s) can be included. In the illustrated embodiment, the plastic tray 26 includes a lip 120 that extends around the perimeter of the tray on top of the sides 112a-d and corners 122 of the tray. The lip facilitates the stacking of a second plastic tray on top of the illustrated plastic tray. The lip also increases the stiffness of the plastic tray, such as by helping the sides to keep their shape. The lip also provides a place to clamp the flexible layer during foam injection and air injection.

The plastic tray 26 may also include radiused or rounded corners 122. The rounded corners 122 increase the strength of the plastic tray 26 compared to squared corners. The rounded corners also facilitate conveying the plastic tray through a conveyor system in a production line; squared corners may sometimes hang up or snag on the conveyor guides of a conveyor system. In the illustrated embodiment, the plastic tray 26 also includes rounded lower edges 124 between the sides 112a-d and the bottom 110.

In the illustrated embodiment of the plastic tray 26, the sides 112a-d of the tray are not perpendicular to the bottom 110, but rather extend outward at a small angle from the bottom to the top of the tray. For example, if the plastic tray is 48 inches×48 inches at the inside bottom, the tray may be 50 inches×50 inches at the inside top. The angled sides facilitate removing the plastic tray from its mold during a thermoforming process of manufacturing the tray, as described below. The plastic tray may further include at least one zero draft structure having a surface that is perpendicular to the bottom. In the embodiment shown, the plastic tray includes three zero draft pads 126. The zero draft pads have an exterior surface that is perpendicular to the bottom of the plastic tray. The zero draft pads may serve two purposes. One purpose is to provide a vertical surface for abutment cups or shields of the foam injection apparatus and the air injection apparatus during the manufacturing operation, making it easier to handle the apparatus and avoid leakage. Another purpose is to provide vertical exterior surfaces that engage the conveyor guides of a conveyor system to facilitate conveying the plastic tray during the manufacturing operation.

FIG. 14 illustrates another embodiment of a plastic tray 130 according to the invention. The plastic tray 130 is similar to the plastic tray 26 described above. It includes a plurality of stiffening ribs 114 in the bottom of the tray. A plurality of offsets 116 are formed in the sides of the tray to increase the rigidity of the sides. The plastic tray also includes a plurality of locking protrusions 132 that are shorter than the protrusions 118 described above. Four protrusions 132 are formed in each of the four sides of the tray. The plastic tray also includes a lip 134 to facilitate stacking the tray. The tray further includes rounded corners 122. The tray includes three zero draft pads 126 with openings 34 and 54 formed through the pads.

The plastic trays according to the invention can be produced by any suitable manufacturing process. In one embodiment, the plastic trays are produced by a thermoforming process such as vacuum thermoforming. Typical vacuum thermoforming equipment includes a mold that has a shape opposite that of the plastic tray (in other words, the mold is the “positive” of the plastic tray). The mold is heated, and a sheet of thermoformable plastic is heated to its softening point. Then the mold and the plastic sheet are brought together such that the plastic sheet deforms over the positive shape of the mold. The mold includes small holes that enable a vacuum to be pulled on the plastic sheet so that the sheet follows the contours of the mold. The mold and the now formed plastic tray are allowed to cool. Then the tray is removed from the mold and subjected to a trimming operation to remove any flashing. Openings are then cut through the sides of the tray.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A mold for manufacturing a simulated stone product comprising:
a flexible layer having a mold cavity in the shape of the simulated stone product, the flexible layer including a first surface in which the mold cavity is formed and a second surface opposite the first surface;
a structural foam that conforms to the shape of the second surface of the flexible layer and provides support to the second surface; and
a plastic tray holding the structural foam and the flexible layer.

2. The mold according to claim 1 wherein the tray includes at least one opening for introducing the structural foam between the tray and the flexible layer.

3. The mold according to claim 2 wherein the opening is located in a first side of the tray, and the tray further includes a second opening in a second side of the tray opposite the first side.

4. The mold according to claim 1 wherein the tray includes at least one stiffening structure that increases rigidity of the tray.

5. The mold according to claim 4 wherein the at least one stiffening structure includes a plurality of ribs.

6. The mold according to claim 1 wherein the tray includes at least one locking structure that locks the structural foam inside the tray.

7. The mold according to claim 1 wherein the tray includes at least one stacking structure that facilitates stacking the tray with a second tray.

8. The mold according to claim 1 wherein the tray includes rounded corners.

9. The mold according to claim 1 wherein the flexible layer is made from a curable rubber material.

10. A mold for manufacturing a simulated stone product comprising:
a flexible layer having a mold cavity in the shape of the simulated stone product, the flexible layer including a first surface in which the mold cavity is formed and a second surface opposite the first surface;
a structural foam that conforms to the shape of the second surface of the flexible layer and provides support to the second surface; and
a plastic tray holding the structural foam and the flexible layer, wherein the tray includes a bottom, and at least one side having a major exterior surface that is nonperpendicular relative to the bottom, and wherein the side of the tray includes at least one zero draft structure having a surface that is perpendicular to the bottom.

11. A mold for manufacturing a simulated stone product comprising:
a flexible layer having a mold cavity in the shape of the simulated stone product, the flexible layer including a first surface in which the mold cavity is formed and a second surface opposite the first surface;
a structural foam that conforms to the shape of the second surface of the flexible layer and provides support to the second surface; and
a flexible plastic tray holding the structural foam and the flexible layer.

12. A plastic tray for constructing a mold to manufacture a simulated stone product comprising:
a plastic tray structured to hold a flexible layer having a mold cavity in the shape of the simulated stone product, the flexible layer including a first surface in which the mold cavity is formed and a second surface opposite the first surface, and the tray structured to hold a structural foam that conforms to the shape of the second surface of the flexible layer and provides support to the second surface;
the tray including at least one opening for introducing the structural foam between the tray and the flexible layer; and
the tray including at least one stiffening structure that increases rigidity of the tray.

13. The plastic tray according to claim 12 wherein the tray further includes at least one locking structure that locks the structural foam inside the tray.

14. The plastic tray according to claim 12 wherein the tray further includes at least one stacking structure that facilitates stacking the tray with a second tray.

15. The plastic tray according to claim 12 wherein the tray further includes rounded corners.

16. The plastic tray according to claim 12 wherein the tray includes a bottom, and at least one side having a major exterior surface that is nonperpendicular relative to the bottom, and wherein the side of the tray includes at least one zero draft structure having a surface that is perpendicular to the bottom.

17. A method of manufacturing a simulated stone product comprising:
applying a flexible layer over a master mold that includes a natural stone protruding from a base, so that the flexible layer conforms to the shape of the protruding natural stone to form a mold cavity in a first surface of the flexible layer, the flexible layer including a second surface opposite the first surface;
positioning a plastic tray over the master mold to enclose the flexible layer;
introducing a structural foam between the plastic tray and the flexible layer, so that the foam conforms to the shape of the second surface of the flexible layer and provides support to the second surface;
removing the plastic tray, the structural foam and the flexible layer from the master mold;
forming a production mold by positioning the plastic tray, the structural foam and the flexible layer so that the plastic tray holds the structural foam and the flexible layer, and the structural foam provides support to the second surface of the flexible layer;
introducing a castable material into the mold cavity in the first surface of the flexible layer;
allowing the castable material to harden to form the simulated stone product; and
removing the simulated stone product from the mold cavity.

18. The method according to claim 17 comprising the additional steps of positioning a rigid fixture over the plastic tray after positioning the plastic tray over the master mold, and removing the fixture after introducing the structural foam.

19. The method according to claim 17 wherein the plastic tray includes at least one opening for introducing the structural foam between the tray and the flexible layer.

20. The method according to claim 17 wherein the plastic tray includes at least one stiffening structure that increases rigidity of the tray.

21. The method according to claim 17 wherein the plastic tray includes at least one locking structure that locks the structural foam inside the tray.
